(19) United States
(12) Patent Application Publication
(10) Pub. No.: US 2009/0106516 A1
(43) Pub. Date: Apr. 23, 2009

(54) METHOD AND APPARATUS FOR PREVENTING ERRONEOUS WRITING OF DATA

(75) Inventors: Fred Chen, Taipei (TW); George Yang, Taipei (TW)

Correspondence Address: APEX JURIS, PLLC, 12733 LAKE CITY WAY NORTHEAST, SEATTLE, WA, 98125, US

(73) Assignee: INVENTEC BESTA CO., LTD., Taipei (TW)

(21) Appl. No.: 12/014,928

(22) Filed: Jan. 16, 2008

(30) Foreign Application Priority Data
Oct. 19, 2007 (TW) 096139260

(51) Int. Cl. G06F 12/14

(52) U.S. Cl. 711/163; 711/E12.093

(57) ABSTRACT

A method for preventing erroneous writing of data includes the steps of: providing a memory positioned in a writing protection state, connecting the memory to a host computer installed with a control program, using the control program to control the memory to remove the writing protection state and writing external data into the memory. Whereby, the erroneous writing of the external data is prevented and the safety of internal data of the memory is protected accurately.

### CROSS-REFERENCES TO RELATED APPLICATIONS

This non-provisional application claims priority under 35 U.S.C. §119(a) on Patent Application No(s). 096139260 filed in Taiwan, R.O.C. on Oct. 19, 2007, the entire contents of which are hereby incorporated by reference.

### FIELD OF THE INVENTION

The present invention relates to an apparatus and method for data writing protection, and more particularly to an apparatus and method for preventing erroneous writing of data.

### BACKGROUND OF THE INVENTION

Accompanying the progress of information, many data storable electronic products are developed toward light weight, thin, short and small size so as to allow a user to carry them conveniently, and more particularly to a USB thumb disk inbuilt with a flash memory, not only it is carried very conveniently, but also a memory capacity of storing data also becomes larger. Therefore, it becomes the people's favorite.

For preventing an improper person to delete data stored in a USB thumb disk arbitrarily or write new data into cover the original stored data to cause a user's serious loss, a notch disposed on one side of plastic housing of the USB thumb disk and a writing protection switch sheet is disposed in the notch. A user may adjust a position of the writing protection switch sheet to change the flash memory from a writing accessible state to a writing protection state or vice versa to prevent the data stored in the USB thumb disk from being deleted erroneously or covered.

However, a user must first check the position of the writing protection switch sheet before using the USB thumb disk every time or data cannot be written in or deleted; it is very inconvenient. If the user forgets adjusting a flash memory to be a writing protection state, he may possibly delete or cover the original stored data to cause the user serious loss and the USB thumb disk to have no way to make certain the safety of data even if it is provided with the writing protection switch sheet.

### SUMMARY OF THE INVENTION

For improving the deficit mentioned above, always maintaining a writing protection state to prevent a user from forgetting adjusting a memory to be a writing protection state to avoid original stored data to be written in or deleted so as to effectively make certain the safety of the original stored data when the user uses a USB thumb disk every time, the present invention is proposed.

The present invention proposes a method for preventing erroneous writing of data, including the steps of: providing memory in a writing protection state; connecting a memory to a host computer installed with a control program; using the control program to control the memory to remove the writing protection state; and writing external data into the memory.

The present invention also proposes an apparatus for preventing erroneous writing of data connected to one host computer installed with a control program, including: a memory, provided with a writing protection state; a connection interface, used for connecting to a host computer accessing the memory through the connection interface; and a control module, used for controlling the memory positioned in the writing protection state, the memory being controlled to remove the writing protection state depending on a switch command to allow the host computer to write external data into the memory when the control program sends the switch command to the control module.

When the memory is connected to the host computer every time, according to the present invention, the memory is preset as the writing protection state, a user may read internal data of the memory, but is unable to write external data into the memory or delete the internal data of the memory to prevent the internal data from being written erroneously to cover or deleted to cause the user a serious loss. When the user wants to write in the external data, he used the control program to control the memory to remove the writing protection state and may write the external data into the memory through the host computer. The memory will then be returned to the writing protection state after the user terminates the connection of the memory, therefore, not only the operation is very convenient, but also the safety of the internal data of the memory can be protected accurately and effectively.

### BRIEF DESCRIPTION OF THE DRAWINGS

The present invention can be more fully understood by reference to the following description and accompanying drawings, in which:

FIG. 1 is a flowchart, showing a method for preventing erroneous writing of data of a preferred embodiment according to the present invention; and

FIG. 2 is a block diagram, showing an apparatus for preventing erroneous writing of data of a preferred embodiment according to the present invention.

### DESCRIPTION OF THE PREFERRED EMBODIEMENTS

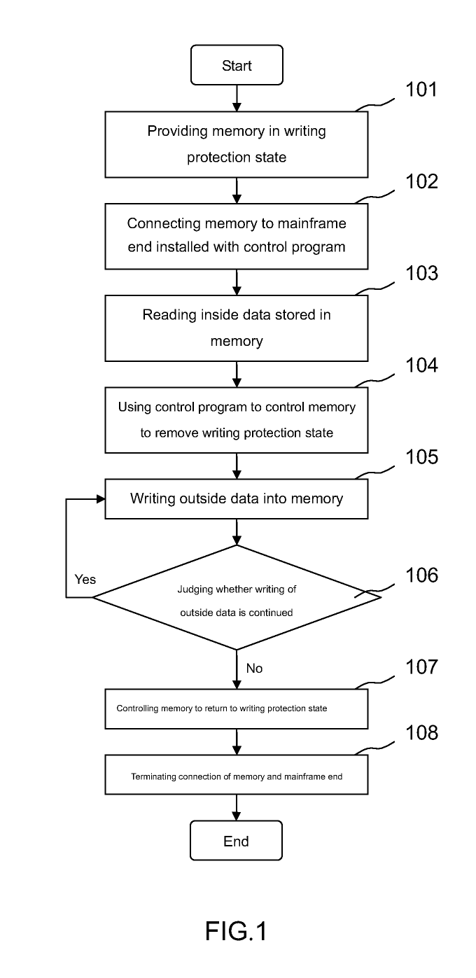

Please refer to FIG. 1. FIG. 1 is a flowchart, showing a method for preventing erroneous writing of data of a preferred embodiment according to the present invention.

A method for preventing erroneous writing of data according to the present invention includes the steps of:

Step 101: providing a memory 10 positioned in a writing protection state.

When the memory 10 is positioned in the writing protection state, it is unable to write external data into the memory 10. Besides, the memory 10 may be a non-volatile memory or volatile memory, in which the non-volatile memory can be ROM, PROM, EAROM, EPROM, EEPROM or flash memory, and the volatile memory can be DRAM, eDRAM, SRAM, IT-SRAM or Z-RAM.

Step 102: connecting the memory 10 to a host computer 2 installed with a control program 21.

The memory 10 is connected to the host computer 2 installed with the control program 21 through the connection interface 11, in which the connection interface 11 can be USB, SATA, IEEE 1394, PCMCIA, card bus IO, compact flash IO, secure digital IO or memory stick IO.

Step 103: reading internal data stored in the memory 10.

As the memory 10 is positioned in the writing protection state, a user can only read the internal data stored in the memory 10 through the host computer 2, writing commands or deleting commands emitted through the host computer 2 all are in vain to cause the user to be unable to write external data into the memory 10 or delete the internal data of the memory 10 thereby solving the problem that a user must check the position of the writing protection switch sheet when the conventional thumb disk is used every time, and further preventing the user from writing in, covering or deleting the internal data because the writing protection switch sheet is forgotten to adjust.

Step 104: using the control program 21 to control the memory 10 to remove the writing protection state.

When the user wants to write the external data into the memory or delete the internal data of the memory 10, he may then send a switch command to a control module 12 through the control program 21 of the host computer 2 to enable the control module 12 to control the memory 10 to remove the writing protection state depending on the switch command.

Step 105: writing external data into the memory 10.

After the memory 10 removes the writing protection state, a user can then write the external data into the memory 10 or delete the internal data of the memory 10through the host computer 2.

Step 106: judging whether the writing of the external data is continued; if yes, go to Step 105; if no, then go to Step 107.

Step 107: controlling the memory 10 to return to the writing protection state.

When the host computer does not write the external data into the memory 10, the control module 21 of the host computer 2 will then send a switch command to the control module 12 to cause the control module 12 to return to the writing protection state. Besides, the user may send the switch command anytime to control the memory 10 to return to the writing protection state through the control module 21 of the host computer 2.

Step 108: terminating the connection of the memory 10 and the host computer 2.

The connection of the memory 10 and the host computer 2 can then be terminated after the user completes using the memory 10 so as to detach an apparatus 1 for preventing erroneous writing of data from the host computer 2.

Besides, if the user does not use the control program 21 to control the memory 10 to return to the writing protection state after he completes using the memory 10, when the connection of the memory 10 and the host computer 2 is terminated, the control module 12 will then control the memory 10 automatically to return to the writing protection state when the connection of the memory 10 and the host computer 2 is terminated.

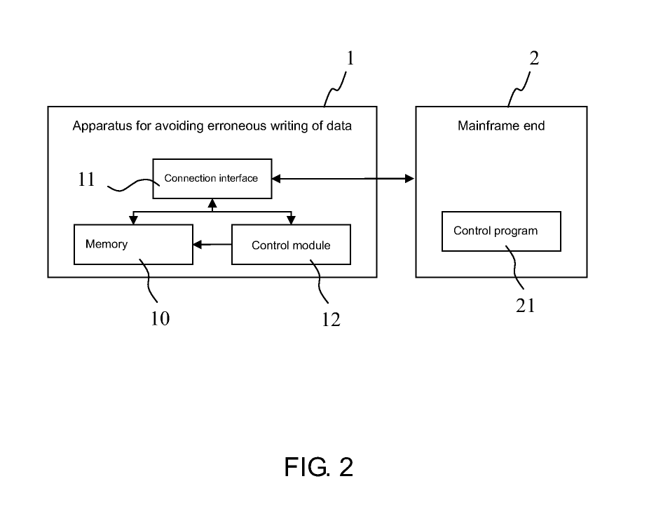

Please refer to FIG. 2. FIG. 2 is a block diagram, showing an apparatus for preventing erroneous writing of data of a preferred embodiment according to the present invention.

An apparatus 1 for preventing erroneous writing of data according to the present invention includes a memory 10, a connection interface 11 and a control module 12.

The memory 10 is provided with a writing protection state. When the memory 10 is positioned in the writing protection state, it is unable to write the external data into the memory 10, in which the memory 10 can be a non-volatile memory or a volatile memory as mentioned above.

The connection interface 11 is used for connecting to the host computer 2, and the host computer 2 accesses the memory 10 through the connection interface 11, in which the host computer 2 may be installed with a control program 21 in advance.

The control module 12 is used for controlling the memory 10 to position in the writing protection state and may control the memory 10 to remove the writing protection state depending on a switch command sent from the control program 21 to enable the host computer 2 to write external data into the memory 10.

An user can read internal data stored in the memory 10 through the host computer 2 to allow the user to surf the internal data when the apparatus 1 for preventing erroneous writing of data of the present invention is connected to the host computer 2 through the connection interface 11. As the memory 10 is positioned in the writing protection state, writing commands or deleting commands emitted by the user through the host computer 2 are all in vain, the user is unable to write external data into the memory 10 or delete the internal data of the memory 10 to prevent the internal data from being written erroneously to covered or deleted to avoid causing the user's serious loss. If the user wants to write the external data into the memory 10 or delete the internal data of the memory 10, he may then send a switch command to the control module 12 through the host computer 2, the control module 12 will then control the memory 10 to remove the writing protection state depending on the switch command and the use can then write the external data into the memory 10 through the host computer 2 or delete the internal data of the memory 10. Besides, the user may send the switch command to control the memory 10 to return to the writing protection state anytime through the control program 21 of the host computer 2.

When the host computer does not write the external data into the memory 10, the control module 21 of the host computer 2 will then send a switch command to the control module 12 to cause the control module 12 to return to the writing protection state. Besides, if the user does not use the control program 21 to control the memory 10 to return to the writing protection state after he completes using the memory 10, when the connection of the memory 10 and the host computer 2 is terminated, the control module 12 will then control the memory 10 automatically to return to the writing protection state when the connection of the memory 10 and the host computer 2 is terminated.

According to the present invention, when the connection interface 11 is connected to the host computer 2 every time, the memory 10 is always positioned in the writing protection state thereby allowing a user to read the internal data of the memory 10 only and be unable to write the external data into the memory 10 or delete the internal data of the memory 10 to prevent the internal data from being written erroneously to cover or deleted to avoid causing the user's serious loss. When the user wants to write in the external data, he uses the control program 21 to control the memory 10 to remove the writing protection state and may write the external data into the memory 10 through the host computer 2. Besides, when the connection interface 11 is not connected to the host computer 2, the memory 10 will then be returned to the writing protection state and the internal data is not written erroneously to cover or deleted even if returning to the writing protection state is forgotten. Therefore, not only the operation is very simple and convenient, but also the safety of the internal data of the memory 10 can be protected accurately and effectively.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for preventing erroneous writing of data, comprising the steps of:
providing a memory positioned in a writing protection state;
connecting the memory to a host computer installed with a control program;
using the control program to control the memory to remove the writing protection state; and
writing external data into the memory.

2. The method for preventing erroneous writing of data according to claim 1, wherein the memory stores at least one set of internal data.

3. The method for preventing erroneous writing of data according to claim 2, further comprising:
reading the internal data of the memory after step of connecting the memory to a host computer installed with a control program.

4. The method for preventing erroneous writing of data according to claim 1, further comprising:
controlling the memory to return to the writing protection state after the step of writing external data to the memory.

5. The method for preventing erroneous writing of data according to claim 4, further comprising:
terminating the connection of the memory and the host computer after the step of controlling the memory to return to the writing protection state.

6. The method for preventing erroneous writing of data according to claim 4, wherein the control program is used to control the memory in the step of controlling the memory to return to the writing protection state.

7. The method for preventing erroneous writing of data according to claim 1, further comprising:
terminating the connection of the memory and the host computer after the step of writing external data to the memory.

8. The method for preventing erroneous writing of data according to claim 7, further comprising:
controlling the memory to return to the writing protection state after the step of terminating the connection of the memory and the host computer.

9. An apparatus for preventing erroneous writing of data, connected to a host computer installed with a control program and comprising:
a memory, provided with a writing protection state;
a connection interface, used for connecting to the host computer accessing the memory through the connection interface; and
a control module, used for connecting the memory to position in the writing protection state, the control module controls the memory to remove the writing protection state depending on a switch command to allow the host computer to write external data into the memory when the control program sends the switch command to the control module.

10. The apparatus for preventing erroneous writing of data according to claim 9, wherein the memory stores at least one set of internal data.

11. The apparatus for preventing erroneous writing of data according to claim 9, wherein the host computer can only read the internal data of the memory when the memory is positioned in the writing protection state.

12. The apparatus for preventing erroneous writing of data according to claim 9, wherein the control module controls the memory to return to the writing protection state depending on the switch command.

13. The apparatus for preventing erroneous writing of data according to claim 9, wherein the control module controls the memory to position in the writing protection state when the connection interface is not connected to the host computer.

14. The apparatus for preventing erroneous writing of data according to claim 9, wherein the control program sends the switch command to cause the control module to control the memory to return to the writing protection state when the host computer does not write the external data into the memory.
